(19) United States
(12) Patent Application Publication
(10) Pub. No.: US 2014/0304681 A1
(43) Pub. Date: Oct. 9, 2014

(54) User Interfaces, Methods, and Systems for Developing Computer Applications Using Artwork

(71) Applicants: Narciso B. Jaramillo, Piedmont, CA (US); Mark Shepherd, Tiburon, CA (US)

(72) Inventors: Narciso B. Jaramillo, Piedmont, CA (US); Mark Shepherd, Tiburon, CA (US)

(73) Assignee: Adobe Systems Incorporated, San Jose, CA (US)

(21) Appl. No.: 11/833,506

(22) Filed: Aug. 3, 2007

(51) Int. Cl. G06F 9/44

(52) U.S. Cl. 717/107

(57) ABSTRACT

Methods and systems for using artwork to develop computer applications in ways that preserve the artwork's appearance and layout, including by importing the artwork and selectively replacing potions with functional components. One embodiment comprises a method for developing an application that involves displaying artwork in a design view area. The method may involve receiving a selection of a component-type for a component to be added and/or receiving a selection of an artwork fragment to be replaced by the component. The method may further involve removing the artwork fragment and inserting the component in its place. Embodiments also facilitate identifying and selecting artwork portions or objects. And, embodiments also provide tools and functions that facilitate the use and management of multiple artwork fragments, for example the use of multiple portions of an artwork to define or be assigned to the different states or parts of a component.

### FIELD OF THE INVENTION

The present invention relates generally to using artwork to develop computer applications in ways that preserve the artwork's appearance and/or layout.

### BACKGROUND

The design and development process for many computer applications, including desktop applications, Web pages, and rich Internet applications, generally involves separate stages and often involves two or more sets of people with very different skill sets. Generally, there are designers who generate images of an application's appearance, for example, using a drawing program like Adobe® Photoshop®. Designers also often separately write specifications of how they want the application to behave, for example, when the user moves the mouse over a given part of the screen. Developers then take the images and specifications and develop a working application, generally by manually coding such an application. For example, in the context of web applications, a developer may first lay out a set of HTML tables or CSS stylesheets, then slice a designer's mockups into small pieces which are inserted into the tables or referenced by the CSS. The developer typically does this by “eyeballing” positions and then checking to see if the layout is the same. This is typically an error-prone process, in which the original appearance of the design can easily be incorrectly translated.

Similar problems are present in the design and development of rich Internet and desktop applications. Generally, the two-stage design-development process is subject to various disadvantages with respect to efficiency and accuracy of both the intended layout (where objects appear) and behavior (how objects act). Discrepancies often require additional iterations of the design-development process and, thus, additional effort by both designer and developer.

The use of declarative languages, platforms like the Adobe's® Flex® platform, and other technologies have helped reduce the gap in the design and development process. For example, declarative languages such as HTML and XML variants and related tools simplify assembling applications in many respects. However, inefficiencies and inaccurate artwork translation continue to hinder application development and there remains a substantial disconnect between artwork and application. While existing languages and tools provide flexibility in certain respects, they fail to adequately facilitate translation of a design image or other artwork to a collection of functional objects or other components that make a working application. In short, the path from a designer's broad graphical conception and functional intentions to a functioning application remains complicated and subject to inaccuracies and inefficiencies. The process of piecing apart and restructuring design artwork into a working application layout and a set of components remains both tedious and error-prone and is a commonly acknowledged pain point in the application design/development community.

### SUMMARY

Embodiments of the present invention provide methods and systems for using artwork to develop computer applications in ways that preserve the artwork's appearance and layout. Embodiments of the present invention use artwork directly in an application and selectively replace potions of (or objects in) the artwork with functional components, such as buttons, lists, and menus. Such functional components may be given the appearance of the artwork portions (or objects) that they replace, thus maintaining the appearance of the original artwork. Embodiments of the invention also facilitate identifying and selecting artwork portions or objects for use in creating functional components. And, embodiments of the invention also provide tools and functions that facilitate the use or management of multiple artwork fragments, for example, the use of multiple portions of artwork to define different states of a given component. As used herein, the term “state” with respect to a component, refers to an appearance of a component under a specific condition, for example, the normal state of a button component is the button's appearance under normal conditions, the mouse-over state of a button component is the button's appearance when a user's mouse is placed over the button, etc.

One embodiment of the present invention is a method of developing an application in an application development environment comprising displaying artwork in a design view area. The artwork may be multi-layered, contain groups and subgroups of objects, and/or may comprise visible and invisible objects. The method may comprise receiving a selection of a selected-component-type for a component to be added and/or receiving a selection of a selected-fragment of the artwork. The method may further comprise replacing the selected-fragment with the component in the design view area by removing the fragment and inserting the component at the fragment's prior location. The selected-fragment appearance and other characteristics may be used to define the component, for example, by associating a bitmap from the selected-fragment with a particular part or state of the component. The component may have a function or other behavior associated with it. The method may comprise receiving multiple selections of artwork fragments and receiving instructions to assign some or all of the fragments to a particular part or state of the component.

One embodiment of the present invention is a method of image fragment selection comprising importing and displaying an artwork in a design view area and providing a selection tool that allows a developer to use a selector to select a portion of the artwork. The method may further comprise receiving a selection of a selected-portion of the artwork displayed in the design view area and identifying visible and invisible artwork fragments that occupy the selected-portion. The artwork fragments that are identified as occupying the selected-portion may be those that are entirely within the selected-portion or those that are either entirely or partially within the selected-portion.

One embodiment of the present invention is a method of associating multiple image fragments with an application component comprising displaying an artwork, receiving identification of multiple artwork fragments, providing an image-fragment-list comprising the identified fragments, and receiving instructions to assign a fragment to a component. The method may further comprise receiving an instruction to add to, delete from, or modify the image fragments in the image-fragment-list. The method may comprise receiving instructions to assign additional fragments to the component, each fragment assigned to a state or part of the component.

In other embodiments, a computer-readable medium (such as, for example random access memory or a computer disk) comprises code for carrying out these methods.

These embodiments are mentioned not to limit or define the invention, but to provide examples of embodiments of the invention to aid understanding thereof. Embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIGS. 1a-1b illustrate an exemplary interface of an application development tool according to one embodiment of the present invention;

FIGS. 2a-2c are system diagrams illustrating design and development environments according to several embodiments of the present invention;

FIG. 3 illustrates an exemplary spelunking tool of the application development tool depicted in FIGS. 1a-1b according to one embodiment of the present invention;

FIG. 4 illustrates an exemplary scratchpad tool of the application development tool depicted in FIGS. 1a-1b according to one embodiment of the present invention;

FIG. 5 illustrates an exemplary interface for creating a multi-state application component from artwork fragments using the application development tool depicted in FIGS. 1a-1b according to one embodiment of the present invention;

FIG. 6 illustrates the exemplary interface for creating a multi-state application component from artwork fragments using the application development tool depicted in FIG. 5 according to one embodiment of the present invention;

FIG. 7 illustrates the exemplary interface for creating a multi-state application component from artwork fragments using the application development tool depicted in FIG. 5 according to one embodiment of the present invention;

FIG. 8 illustrates an exemplary interface for creating a multi-part application component from artwork fragments using the application development tool depicted in FIGS. 1a-1b according to one embodiment of the present invention;

FIG. 9 illustrates creating a multi-part application component from artwork fragments according to one embodiment of the present invention;

FIG. 10 illustrates creating a multi-part application component from artwork fragments according to one embodiment of the present invention;

FIG. 11 illustrates the appearance of an application development tool interface after a developer has associated artwork fragments into appropriate parts of a multi-part component according to one embodiment of the present invention;

FIG. 12 illustrates the appearance of an application development tool interface after a developer has associated artwork fragments into appropriate parts of a multi-part component according to one embodiment of the present invention;

FIG. 13 illustrates the appearance of an application development tool interface after a developer has associated artwork fragments into appropriate parts of a multi-part component according to one embodiment of the present invention;

FIG. 14 is a flow chart illustrating one method of developing an application in an application development environment according to one embodiment of the present invention;

FIG. 15 is a flow chart illustrating one method of image fragment selection according to one embodiment of the present invention; and

FIG. 16 is a flow chart illustrating one method of associating multiple image fragments with an application component according to one embodiment of the present invention.

### DETAILED DESCRIPTION

Embodiments of the present invention provide methods and systems for converting artwork into an application, while preserving the layout of the original artwork. The invention makes it possible for application developers to take static artwork representing a detailed mockup of an application and directly convert it into working components in a real application, preserving the precise appearance and layout of the original artwork. Generally, “static artwork” is a collection of one or more graphic fragments, each fragment defined by a shape (for example a rectangle, circle, a complex curve), color and fill, effects and filters, size, location, and/or other visual properties. All or part of static artwork may be a bitmap image of one or more graphic fragments. An “application” includes one or more user interface components, each component defined by its type (Button, DataGrid, etc), its skins (the visual appearance of the different states of the components), text properties such as font and size (if the component involves text), sample data (if the component involves dynamic data), and so on. A “component” in the present context refers to any piece of an application or its user interface that has its own encapsulated appearance and/or behavior (e.g. button, checkbox, listbox). A component may or may not have different states and may or may not have one or more skins associated with such states. In this context, the term “skin” refers to the appearance of a component in a given state (for example, its normal state, its mouse-over state, its pressed state, etc.).

### Introduction to Creating an Application Component Using Artwork

In one illustrative embodiment, static artwork created by a designer is used to create an application having functional components. The designer generates a piece of static artwork, for example a vector or bitmap file produced by a visual design tool such as Adobe® Photoshop® or Adobe® Illustrator®. The artwork is a mockup that represents an overall design for a user interface of an application. The designer sends the artwork to a developer for development of the intended application, perhaps with instructions regarding the intended behavior of the components. The developer converts the artwork from its static design mockup form into a working application.

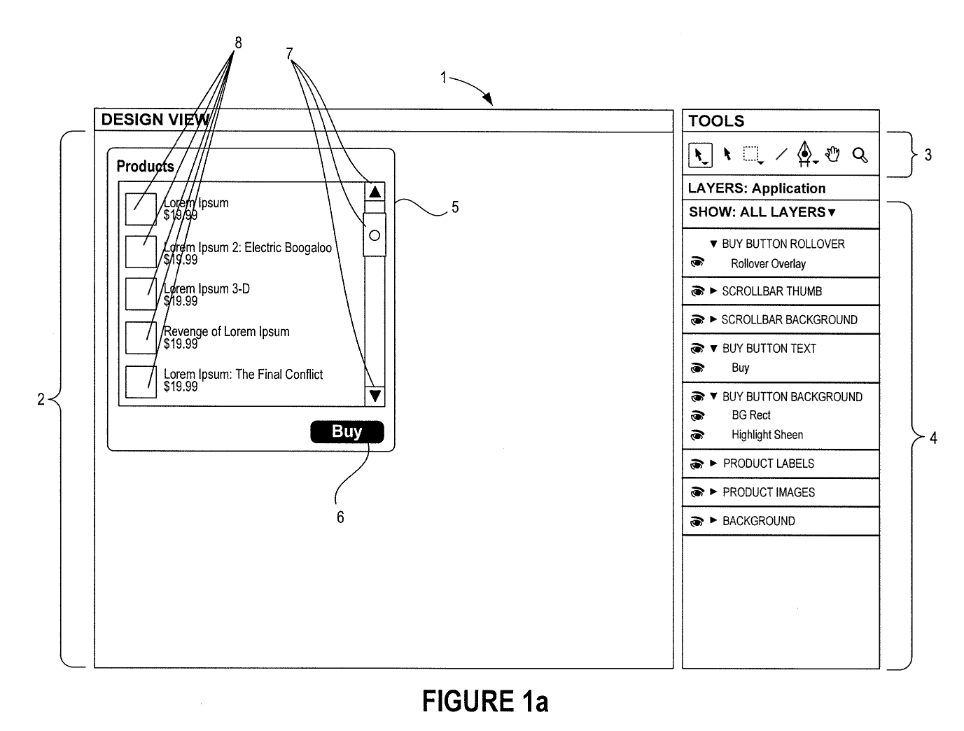

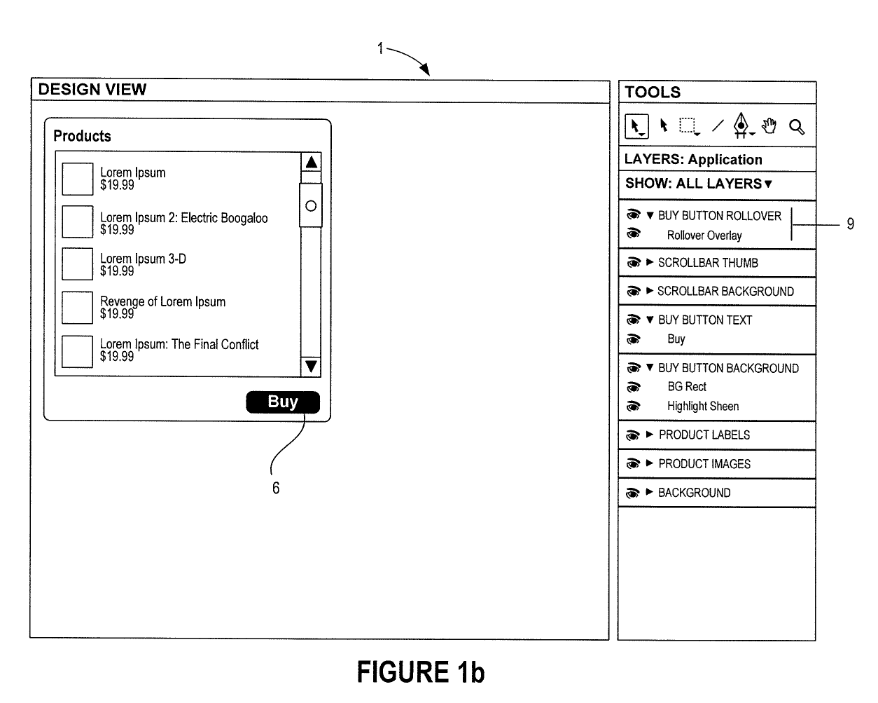

FIGS. 1a and 1b illustrate an exemplary interface of an application development tool. The overall workspace 1 of the application development tool includes a design view area 2, a tools panel 3, and a layers panel 4. In the present example, the user imports or draws a piece of artwork 5 into the design view area 2, which shows the artwork design 5 for a simple product browser application. In this case, all the items in the design view area 2 are raw vector graphics (rectangles with gradient fills, rounded rectangles, arrows, etc.). The artwork 5, among other things, shows the intended appearance of various intended components for the application, including a “Buy” button 6, a scroll bar 7, and various check boxes 8. The tools panel 3 contains various tools for drawing and selecting graphics. The layers panel 4 shows the graphic objects in the design, mapped or otherwise grouped based on the designer specified artwork layers. Such mapping may occur automatically when the artwork is imported into the developer tool. This structure reflects the designer's preferences and may not cleanly map to the final component structure needed in the intended working application. For example, the artwork that will eventually become a “Buy” button 6 may be scattered across different layers of the artwork 5 and thus may not have been grouped together when the artwork 5 was imported.

The developer uses the application development tool to identify portions of the artwork 5 that relate to the intended button component, for example, the image of the “Buy” button 6 displayed on the artwork 5. The developer then creates a new application component that will replace the static “Buy” button 6, but that will have an appearance similar to or the same as the static “Buy” button 6 image. For example, the vector artwork comprising the static “Buy” button may be saved as a separate file and referenced as a state of the new button component, e.g., the normal-state.

FIG. 1b illustrates features of the application development tool that allow the developer to further specify characteristics of the new “Buy” button component 6. In this case, the developer uses the interface of the development tool to specify that the “Buy” button will turn green when the application user mouses over it. The green overlay was specified by the artwork designer as a layer of the original artwork 5 that was imported into the development tool. The application developer turns on the visibility over that layer when the button is in its OVER state. In other words, the developer sets up the button component so that when it is rolled over, the overlay artwork layer is shown. For example, the developer may select the OVER state and use options on the layers panel 4 to specify that the BUY BUTTON ROLLOVER artwork layer is visible in that OVER state. Generally, by directly converting portions of the artwork into individual components and component states, the location and appearance of the original artwork is preserved, even though it has been pieced apart and restructured to fit the requirements of the application component.

This illustrative example is given to introduce the reader to the general subject matter discussed herein. The invention is not limited to this example. The following sections describe various additional embodiments and examples of methods and systems for using artwork to develop computer applications in ways that preserve the artwork's appearance and/or layout.

### Illustrative Design and Development System Environments

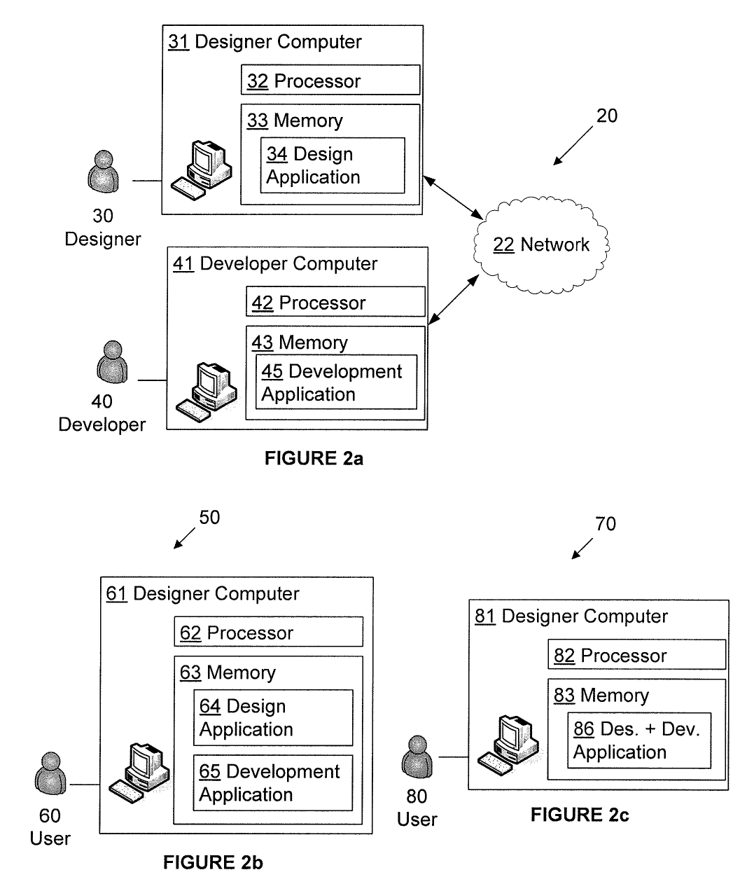

FIGS. 2a-2c are system diagrams illustrating design and development environments according to several embodiments of the present invention. Other embodiments may be utilized. The system 20 shown in FIG. 2a comprises a wired or wireless network 22 connecting a designer 30 using a designer computer 31 and a developer 40 using a developer computer 41. The devices 31, 41 each may comprise a computer-readable medium such as a random access memory (RAM) 33, 43, coupled to a processor 32, 42 that executes computer-executable program instructions stored in memory. Such processors 32, 42 may comprise a microprocessor, an ASIC, a state machine, or other processor, and can be any of a number of computer processors, such as processors from Intel Corporation of Santa Clara, Calif. and Motorola Corporation of Schaumburg, Ill. Such processors comprise, or may be in communication with, media, for example computer-readable media, which stores instructions that, when executed by the processor, cause the processor to perform the steps described herein.

Embodiments of computer-readable media comprise, but are not limited to, an electronic, optical, magnetic, or other storage or transmission device capable of providing a processor with computer-readable instructions. Other examples of suitable media comprise, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, JavaScript, and ActionScript.

In FIG. 2a, the designer computer 31 comprises a design application, for example an application that allows the designer 30 to generate a piece of static artwork such as a vector or bitmap file produced. Exemplary applications include Adobe® Photoshop® and Adobe® Illustrator®, but a variety of suitable applications may be appropriate according to the particular context or embodiment of the present invention. The developer computer 41 comprises a development application 45, for example an application that allows a developer to import static artwork and convert some or all of the artwork to functional items to generate a functional application.

Methods according to the present invention may operate within a single device 50, 70 as shown in FIGS. 2b and 2c. In FIG. 2b, one or more users 60 use a designer computer 61, comprising a processor 62 and memory 63 having both a design application 64 and a development application 65. In FIG. 2c, one or more users 80 use a designer computer 81, comprising a processor 82 and memory 83 having both a design and development application 86 that allows the one or more users 80 to both design artwork and develop an application using the artwork.

Generally, the devices 31, 41, 61, 81 of FIGS. 2a-2c may also comprise a number of external or internal devices such as a mouse, a CD-ROM, DVD, a keyboard, a display, or other input or output devices. Examples of such devices are personal computers, digital assistants, personal digital assistants, cellular phones, mobile phones, smart phones, pagers, digital tablets, laptop computers, Internet appliances, and other processor-based devices. In general, a device may involve any type of processor-based platform that operates on any operating system, such as Microsoft® Windows® or Linux, capable of supporting one or more client application programs. Other applications can be contained in memory 33, 43, 63, 83 and can comprise, for example, a word processing application, a spreadsheet application, an e-mail application, a media player application, an instant messenger application, a presentation application, an Internet browser application, a rich Internet application player 32, a calendar/organizer application, and any suitable application or computer program. Other configurations may also involve server devices, mainframe computers, networked computers, and other system configurations appropriate for the particular context.

Certain embodiments of the present invention relate to systems used to design artwork and develop applications. It will be recognized that this is merely one context for the methods and other features of the invention described herein. For example, certain embodiments will not involve a design application and certain embodiments will not involve the use of imported artwork. In short, the techniques for developing applications and the other features described herein have uses in a variety of contexts, not to be limited by the specific illustrations provided herein. The system shown in FIGS. 2a-2c are merely illustrative and are not intended to recite any system component or feature as essential or necessary to any embodiment of the invention.

### Illustrative Embodiment of Using Artwork in Application Development

In one embodiment of the present invention, a method is provided for a developer to convert artwork into an application. The developer begins by choosing a static artwork file and importing it into a development document within an application authoring tool. The imported artwork is presented to the developer in an interactive window in full fidelity. The developer then follows an interactive process for each component that s/he wants to appear in the resulting application. The developer chooses a certain kind of component to add to the application (e.g. button, checkbox, datagrid, or other pre-built component). Depending on which component is chosen, the application authoring tool will present the developer with a list of portions for the particular component type. For each portion, the developer may select one or more artwork fragments and assign those fragments to given portions. For example, a button component might have several states (for example up, down, over, and disabled) and parts (for example, a label) that may or may not appear different in the different states. The developer could choose several artwork fragments and assign one to each state. As each state is assigned, each artwork fragment is removed from the document and inserted into its own separate document that is associated with the particular component state.

The application authoring tool inserts into the document an instance of each component at the exact location and size of the original artwork representation of the component. The overall screen looks the same, but the portion that the developer has converted is now a working component rather than static artwork. By repeating the per-component process for each component that is desired in the resulting application, the developer accomplishes the desired goal of transforming static artwork into a working application.

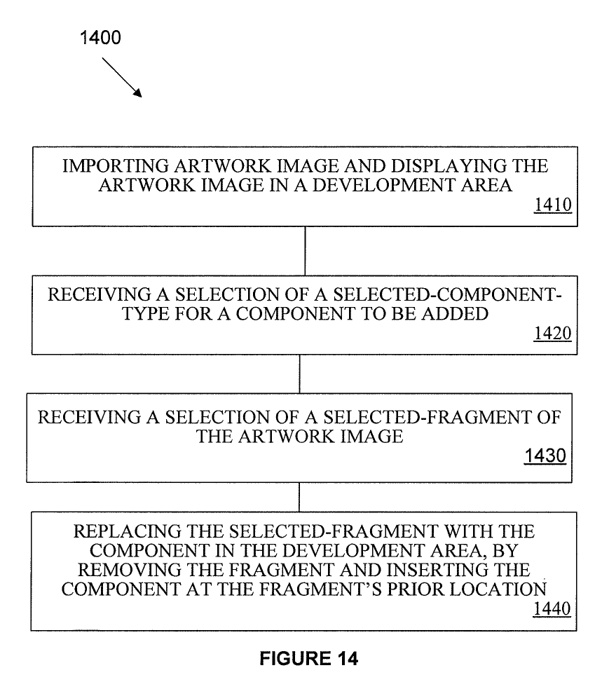

FIG. 14 is a flow chart illustrating one method 1400 of developing an application in an application development environment according to one embodiment of the present invention. The method comprises displaying artwork in a design view area, as shown in block 1410. The artwork may be multi-layered, contain groups and subgroups of objects, and/or may comprise visible and invisible objects. For example, the image may contain multiple layers of overlapping items. The design view area of the application development environment may be any area used to develop an application or part of an application, for example an area used to graphically develop the user interface of an application. The design view area of the application development environment may be a part of an interactive window that allows the developer to select and manipulate displayed items.

The method 1400 may comprise receiving a selection of a selected-component-type for a component to be added, as shown in block 1420. Example component types include buttons, checkboxes, and data grids.

The method 1400 may comprise receiving a selection of a selected-fragment of the artwork, as shown in block 1430. The selected-fragment from the artwork will be used to define the appearance of the component that replaces it. The selected-fragment may be an object defined by a designer of the artwork in the artwork. For example, the object could be a box representing the boundaries of a button intended by the designer. Receiving the selection of the selected-fragment may occur before, after, or during receiving the selection of the selected-component-type.

The method may further comprise replacing the selected-fragment with the component in the design view area, by removing the fragment and inserting the component at the fragment's prior location, as shown in block 1440. The selected-fragment appearance and other characteristics may be used to define the component, for example by associating a bitmap from the selected-fragment with a particular state or part of the component. For example, the selected-fragment from the artwork may be stored in a separate document that is associated with a particular state or part of the component. The component may also have a function or other behavior associated with it.

The method may further comprise receiving multiple selections of artwork fragments and receiving instructions to assign some or all of the fragments to particular states or parts of the component. The method may further comprise receiving a function-selection for the component, the function-selection specifying a behavior of the component during execution or use of the application. The method may further comprise receiving multiple selections of fragments of the artwork and receiving instructions to assign each fragment selected by the multiple selection of fragments to a particular state or part of the component.

### Illustrative Embodiment of a Spelunking Tool

The application development tool may offer features to help the developer identify all the artwork fragments that are part of a given component. A selection or “spelunking” tool allows the developer to drag a selection marquee to approximately cover the screen area of the component that the developer is currently working on defining. The spelunking tool identifies all the individual artwork fragments that visually contribute to that screen area, and sets the authoring tool's ‘current selection’ to the set of fragments that it found. The spelunking tool may ignore the original structure of the artwork (which might be composed of layers, groups, groups within groups, and invisible or visible items) and focuses entirely on finding relevant graphic fragments, regardless of how they fit into the original document structure. Ignoring this structure is advantageous because the document structure as conceived by the original artist is often unrelated to the needs of the developer's task.

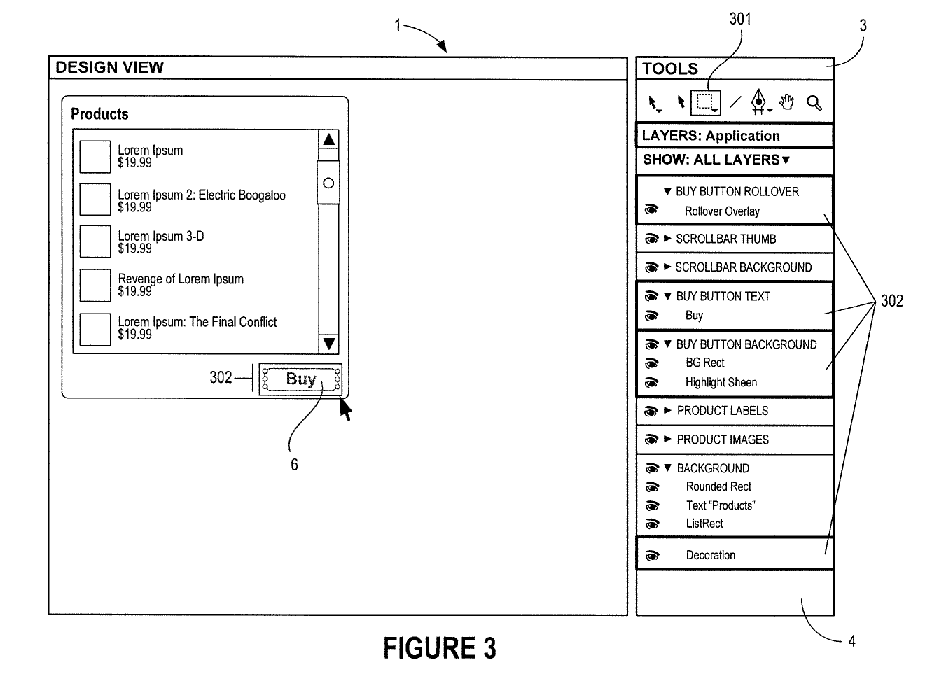

FIG. 3 illustrates an exemplary spelunking tool of the application development tool depicted in FIGS. 1a-1b according to one embodiment of the present invention. As shown in FIG. 3, a developer may select a spelunking tool 301 from the tools panel 3 and drag a marquee rectangle 302 around an area of the screen where the artwork for the “Buy” button 6 is located. The spelunking tool selects all items that are completely contained in the rectangle, including hidden items (such as the rollover overlay, which is hidden in this diagram). This tool is thus specifically useful in cases where a designer has used hidden layers to show alternative states of intended components because it captures artwork fragments from all such layers. All selected fragments 303 are highlighted for the developer by the spelunking tool. Note that a “Decoration” item has been selected in the BACKGROUND layer. This item was not intended to be part of the button, but happens to be in the button area behind the button.

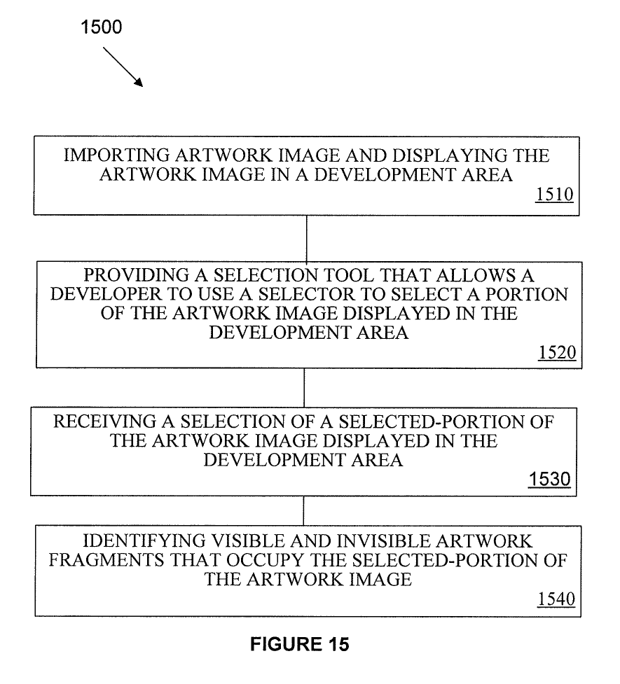

FIG. 15 is a flow chart illustrating one method 1500 of image fragment selection according to one embodiment of the present invention. The method comprises importing an artwork and displaying the artwork in a design view area of an application development environment, as shown in block 1510.

The method 1500 may further comprise providing a selection tool, the selection tool allowing a developer to use a selector to select a portion of the artwork displayed in the design view area, as shown in block 1520. The artwork fragments that are identified as occupying the selected-portion may be those that are entirely within the selected-portion or may be those that are entirely or partially within the selected-portion. The selector may be a selection marquee that is used to approximately cover the screen area of the component that the developer is currently working on defining.

The method 1500 may further comprise receiving a selection of a selected-portion of the artwork displayed in the design view area, as shown in block 1530. For example, a developer may have used the selection tool to make a selection of a portion of an artwork containing various layers of a button object, the button object providing artwork fragments for various intended appearances of the application's button component.

The method 1500 may further comprise identifying visible and invisible artwork fragments that occupy the selected-portion of the artwork displayed in the design view area, as shown in block 1540. For example, the spelunking tool may recognize fragments of the artwork from different layers, whether visible or invisible, that are entirely or partially within the selected-portion of the artwork.

In an alternative embodiment, the application authoring program automatically determines which artwork fragment should be assigned to each component part. For example, if a developer is creating a button, and the developer has selected artwork that includes a text item, the system can convert the background artwork into the normal state for the button, and then extract the style of the text (font, size, etc.) and apply it to the button's built-in text component. The tool may also adjust the text padding of the button to match the location of the text in the mockup. Variations on this basic method are possible, dealing with converting other states of the button (besides the normal state) into a component state or part, or converting selected artwork into the presentation of a data-bound item in a list.

Generally, the application development tool can try to automatically pick apart the artwork and attach fragments to different states or parts using heuristics and/or can provide the developer with a user interface for mapping the selected artwork fragments (or both). Heuristics for automatic mapping include taking multiple selected layers and assuming that they refer to separate states or parts, and looking at the layout of sub-groups of the selected artwork to guess their function (e.g. the thumb, track, and up/down arrows in a scrollbar).

### Illustrative Embodiment of a Scratch Pad Tool

A second feature useful in application development according to an embodiment of the present invention is a “scratchpad” that offers a way for the developer to manipulate a set of artwork fragments. For example, once a developer has used a spelunking tool to identify a set of artwork fragments that pertain to a certain component, the developer can tell the scratchpad to remember that list of fragments. A window or panel may be provided by the application development tool in which the developer can view the list of items that is currently in the scratchpad, and may allow the developer to add and remove items from the list. A scratchpad therefore may allow a developer to easily see selected and accurately manipulate that list of selected items. Such a scratchpad allows the developer to easily and accurately work with a specific set of artwork fragments, for example in preparation for assigning a set of artwork fragments to a component part, as described above.

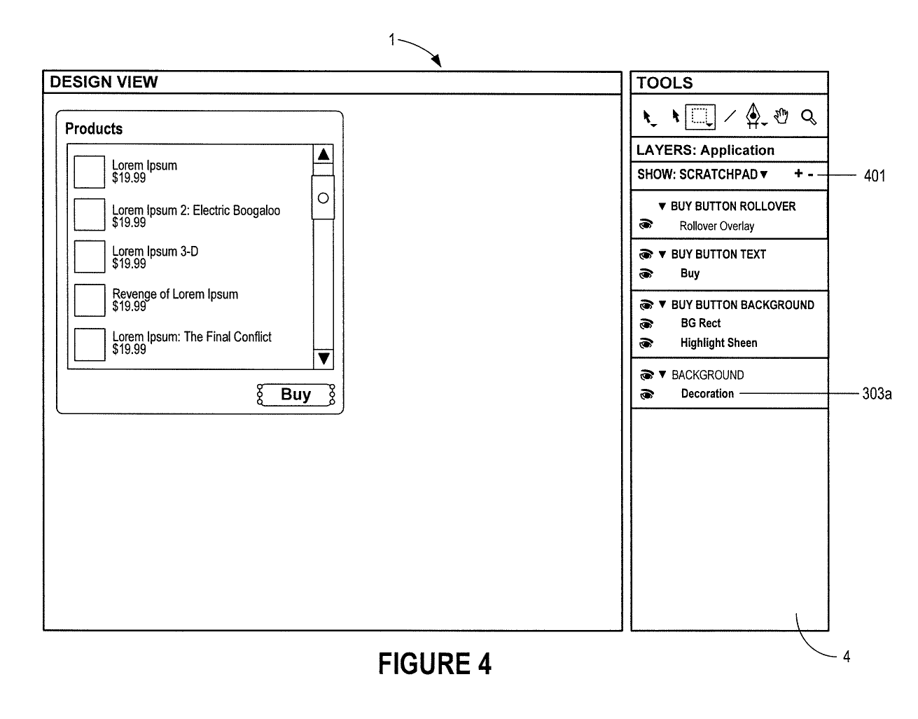

FIG. 4 illustrates an exemplary scratchpad tool of the application development tool depicted in FIGS. 1a-1b according to one embodiment of the present invention. In order to fine-tune a selection of artwork fragments, for example to ensure that only appropriate artwork fragments are selected, a developer may utilize a scratchpad tool. For example, after selecting items with a spelunking tool, a developer may choose to convert the currently selected items into a scratchpad 401. This process may filter the layers lists displayed in the layers panel 4 so that only items that were part of the selection are displayed in a scratchpad 401. The developer can now select the extraneous “Decoration” reference 303a and remove it from the scratchpad, for example using a remove from scratchpad command.

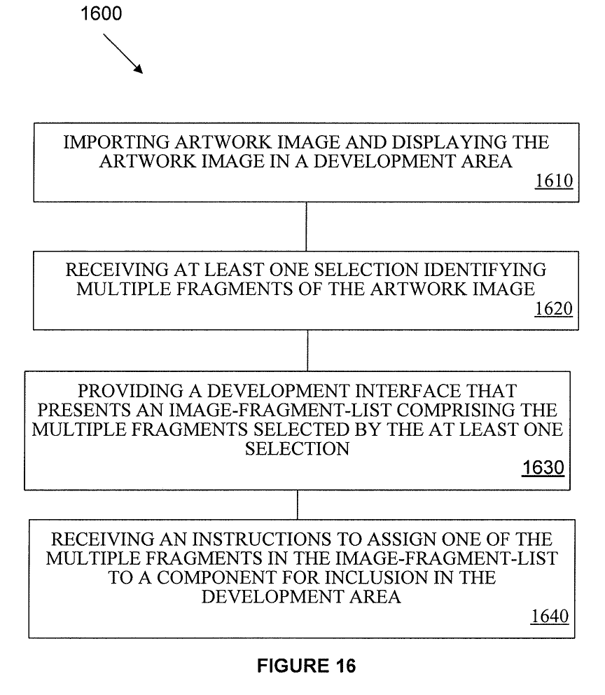

FIG. 16 is a flow chart illustrating one method 1600 of associating multiple image fragments with an application component according to one embodiment of the present invention. The method comprises importing an artwork and displaying the artwork in a design view area of an application development environment, as shown in block 1610.

The method 1600 may further comprise receiving at least one selection identifying multiple fragments of the artwork, as shown in block 1620. For example, such fragments may be selected using a spelunking tool as described above, selected one at a time by a developer, or otherwise selected as appropriate for the circumstances.

The method 1600 may further comprise providing a development interface that presents an image-fragment-list comprising the multiple fragments selected by the at least one selection, as shown in block 1630. Such an image fragment list or scratchpad tool may be a window or panel provided by the application development tool in which the developer can view the items of the list and may allow the developer to add and remove items from the list.

The method 1600 may further comprise receiving instructions to assign one of the multiple fragments in the image-fragment-list to a component for inclusion in the design view area, as shown in block 1640. For example, such an instruction could specify that a fragment in the image-fragment-list is to be associated with a particular state of a button component such that the particular state of the button component will have the appearance of the fragment.

### Illustrative Embodiment of Creating a Multi-state Component From Artwork Fragments

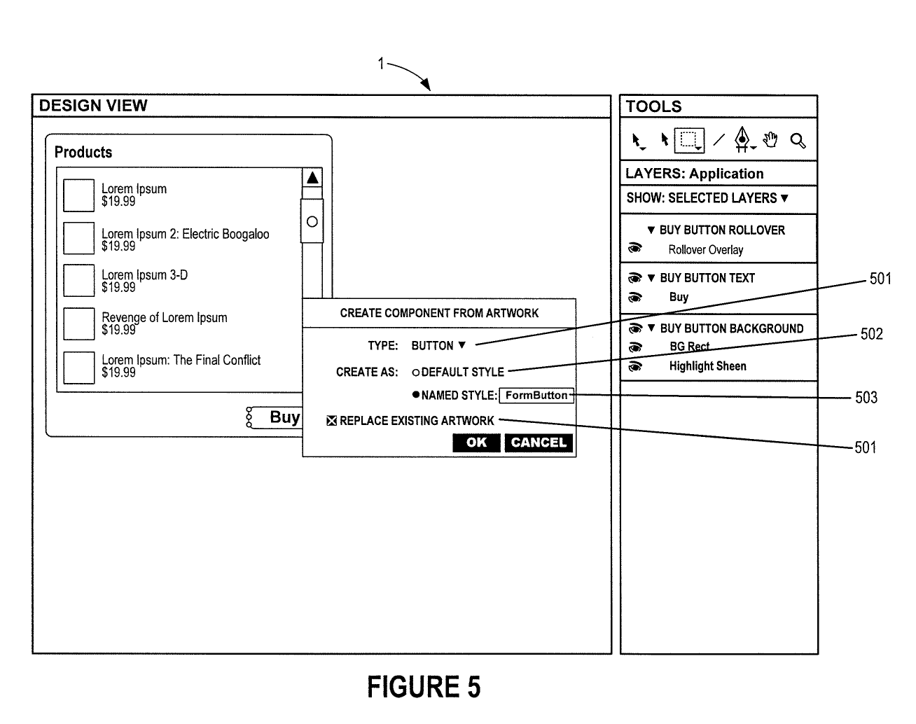

FIG. 5 illustrates an exemplary interface for creating a multi-state application component from artwork fragments using the application development tool depicted in FIGS. 1a-1b according to one embodiment of the present invention. Once a developer has selected the artwork fragments that will make up the component states or parts, the present invention provides simple and convenient techniques for converting/replacing the fragments with a working component. For example, a developer may select a CREATE COMPONENT FROM ARTWORK TOOL using a menu or dialog of the application development tool interface. For example, the developer may use a dialog 502 to specify or choose what type of component to create. The interface may provide the developer with a list of built-in components, as well as an option to create or customize a component (not shown). The developer may also choose whether to make this the default appearance of the given component or to create a named style (usable by other similar components) for the new appearance. In FIG. 5, the tool shows that the developer is creating a style named “FormButton,” as shown by the named style selection 503. Finally, the developer can choose 504 whether or not to remove the original artwork when creating the new component.

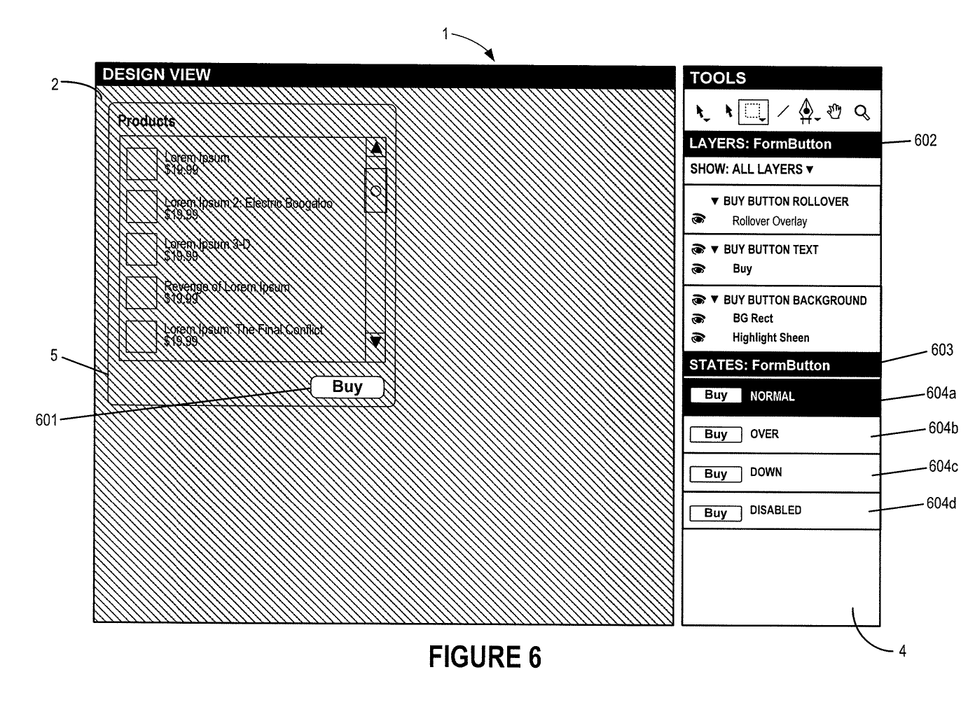

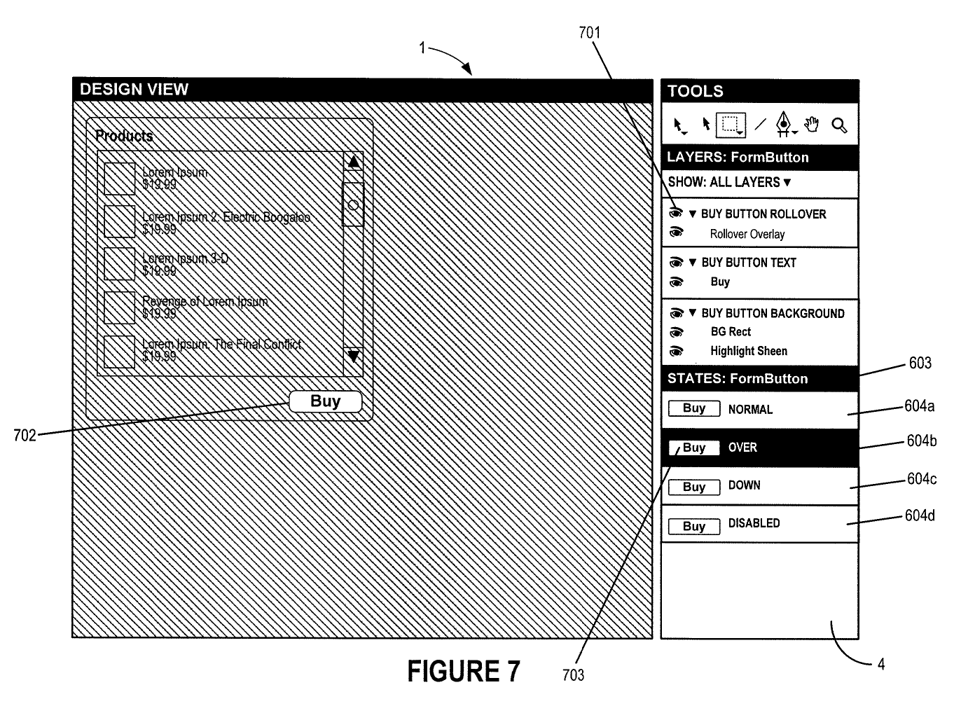

FIGS. 6-7 further illustrate the exemplary interface for creating a multi-state application component from artwork fragments using the application development tool depicted in FIG. 5 according to one embodiment of the present invention. After the developer initiates creation of a component as illustrated in FIG. 5, several things may happen. A real component, in this case a button 601, is created at the exact location and size of the original artwork. The original artwork for the button 6 is extracted into the states or parts of the newly created button component 601. The developer is then able to edit the newly created button characteristics. Other portions of the design may be grayed out (or otherwise unavailable for modification) while the developer edits the button component characteristics. In addition, a title 602 on the layers panel 4 may change, e.g., to “LAYERS: FormButton,” to reflect that only the layers for the button are being edited.

Also shown in FIG. 6 is a “States” panel 603 that shows the different states of the button component. As shown, all of the states 604 are the same because the developer has yet to customize them—each is given a default appearance derived from the selected fragment of the visible layer of the artwork. In certain other embodiments, the states of the component will automatically populate with fragments from different layers of the artwork. Such automatic population may be based on any suitable heuristic and may, for example, correlate an artwork layer name or other identification with a component state name or other identification.

While FIG. 6 shows the “NORMAL” state 604a as selected for editing in the design view area 2, FIG. 7 illustrates the “OVER” state 604b as selected for editing in the design view area 2. Here, the developer wants to set up the button so that when it is rolled over, the overlay artwork layer is shown. Thus, the developer has selected the OVER state 604b in the States panel 603. The developer may then use the Layers panel 602 to toggle and make the BUY BUTTON ROLLOVER artwork layer visible in the design view area 2. Here, the developer clicks on an eyeball icon 701 to specify that whenever the button is in the OVER state, the layer and its contents are toggled on. This customized appearance is now visible in the design view button image 702 and in the OVER thumbnail image 703 in the States panel 603.

Other chances may be made to customize the appearance of a component in one or more given states. For example, rather than showing a particular layer in order to make the button appear disabled, the developer could choose the disabled state 604d and simply set the color, for example by changing a “BG Rect” characteristic to “light gray.”

### Illustrative Embodiment of Creating a Multi-Part Component from Artwork Fragments

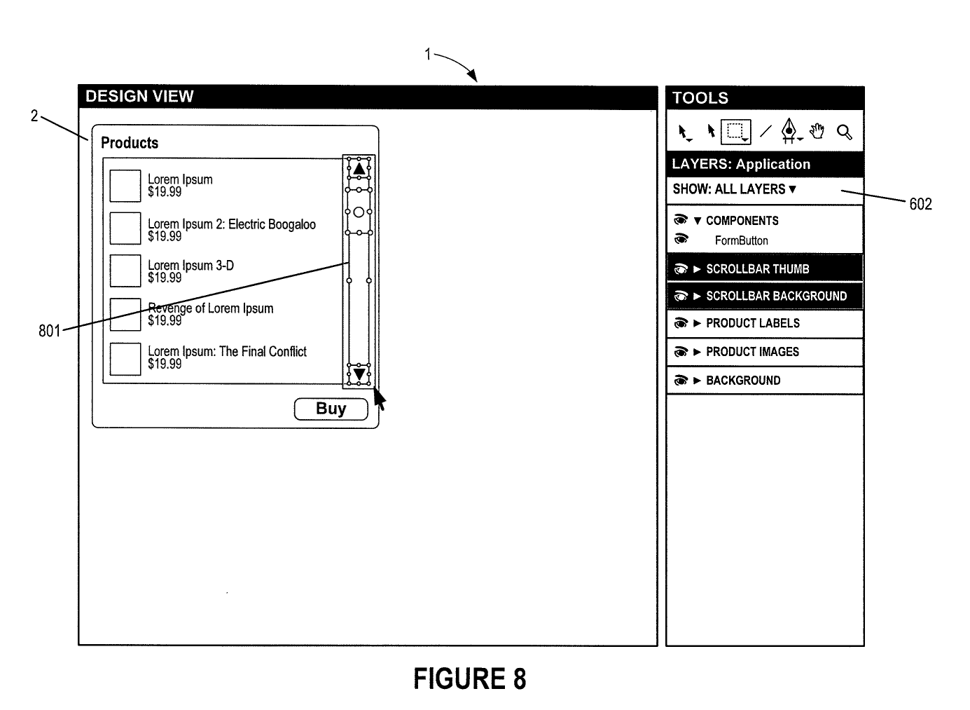

FIGS. 8-10 illustrate an exemplary interface for creating a multi-part application component from artwork fragments using the application development tool depicted in FIGS. 1a-1b according to one embodiment of the present invention. Specifically, artwork fragments are converted to make a scrollbar component. Scrollbars are more complex than buttons because they have multiple parts, for example a thumb that the user can drag in order to scroll up or down, a track that the thumb slides on and an up arrow and down arrow that the user can click in order to scroll incrementally. Each of these parts may have its own states. For example, the thumb, up arrow, and down arrow each may act like a button, with four states (normal, over, down, and disabled), while the track may have only two states, normal and disabled.

FIG. 8 illustrates a spelunking tool used to select the scrollbar artwork 801. This artwork is split into two layers in the layers panel 602. The exact structure of the individual artwork items is not shown here, but can be assumed to contain hidden layers with the rollover states of the up arrow, down arrow, etc.

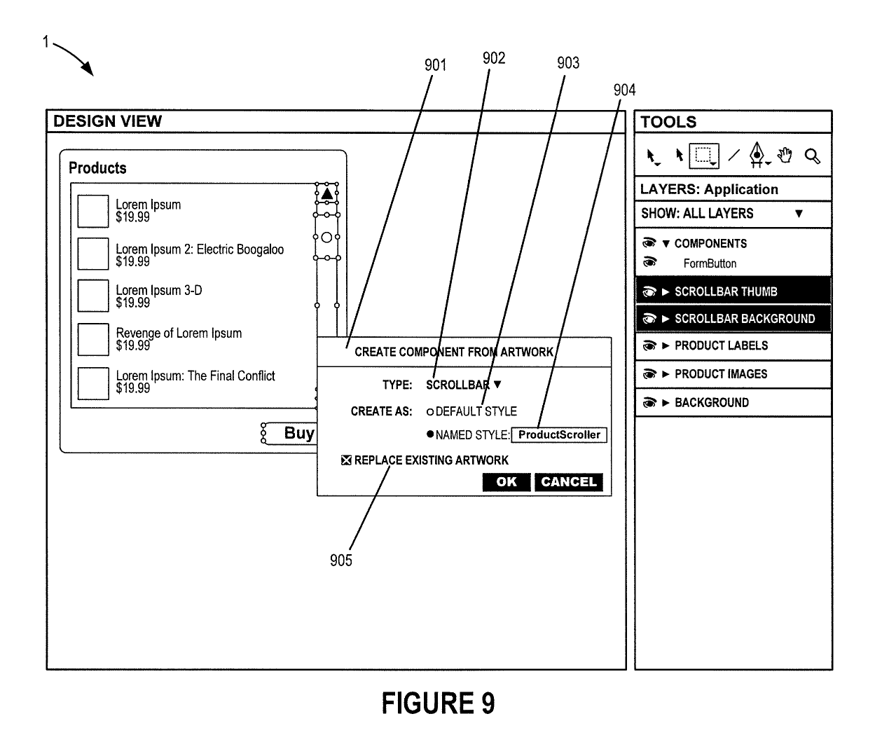

FIG. 9 illustrates initiation of creating a multi-part (scrollbar) application component from artwork fragments. Once artwork fragments are selected, the developer selects a CREATE COMPONENT FROM ARTWORK tool 901 specifying a scrollbar component type 902 to create as a style named “ProductScroller,” as shown by the named style selection 903. The developer has also chosen to replace the existing artwork option 905.

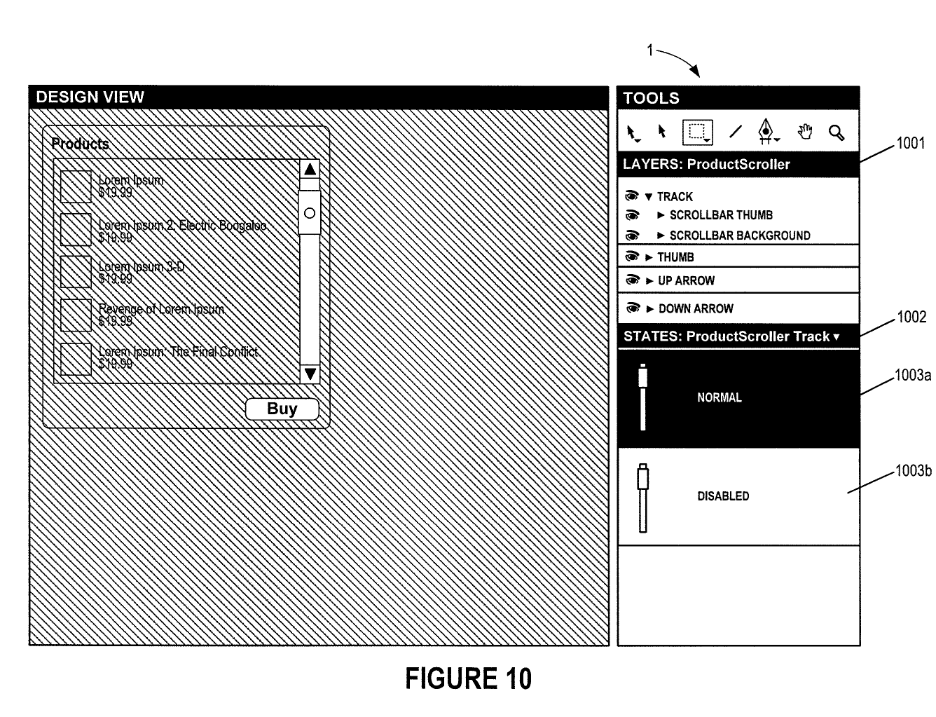

FIG. 10 illustrates the user interface after the developer has invoked the CREATE COMPONENT FROM ARTWORK tool and created the component. The layers panel 1001 specifies the four parts of the newly created scrollbar component—the track, thumb, up arrow, and down arrow. Preferably, these layer parts may not be deleted by the developer. Because the scrollbar has multiple parts, the developer may select which artwork goes with which part. By default, all of the initial artwork is placed into the track part and the other parts are left empty. The developer is then able to associate artwork with appropriate parts, for example by using normal drawing gestures such as cutting and pasting, dragging and dropping, and otherwise using the interface to make the associations. The states panel 1002 shows the states of a particular part—one part at a time. In FIG. 10, states panel 1002 shows the normal and disabled states 1003 for the track part of the scrollbar component. The interface may allow the developer to switch which part the states panel 1002 is inspecting.

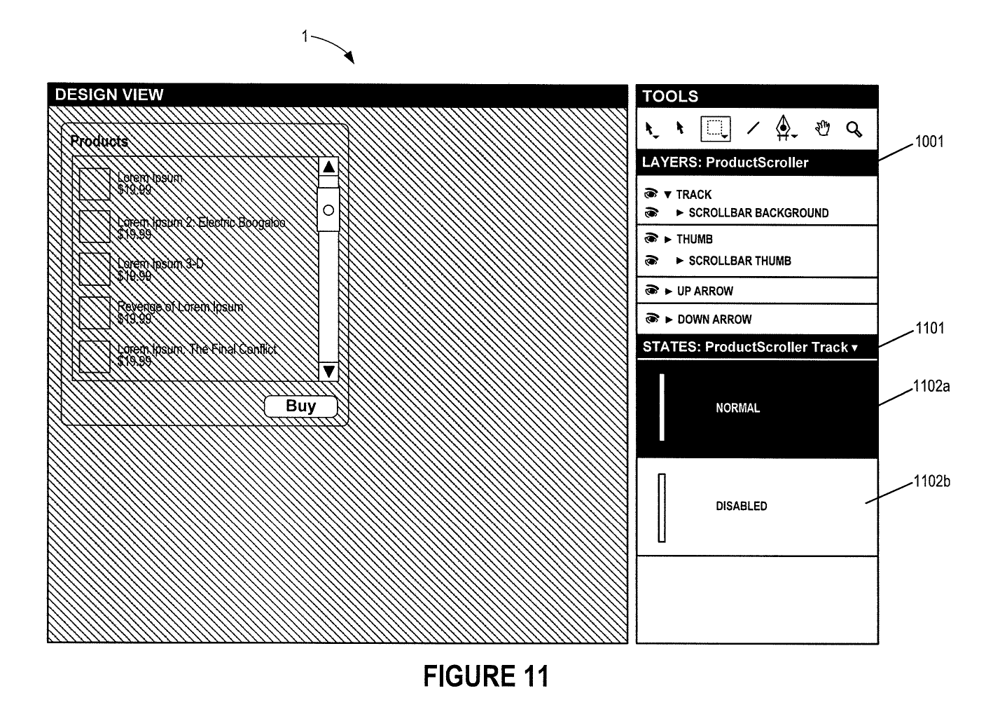

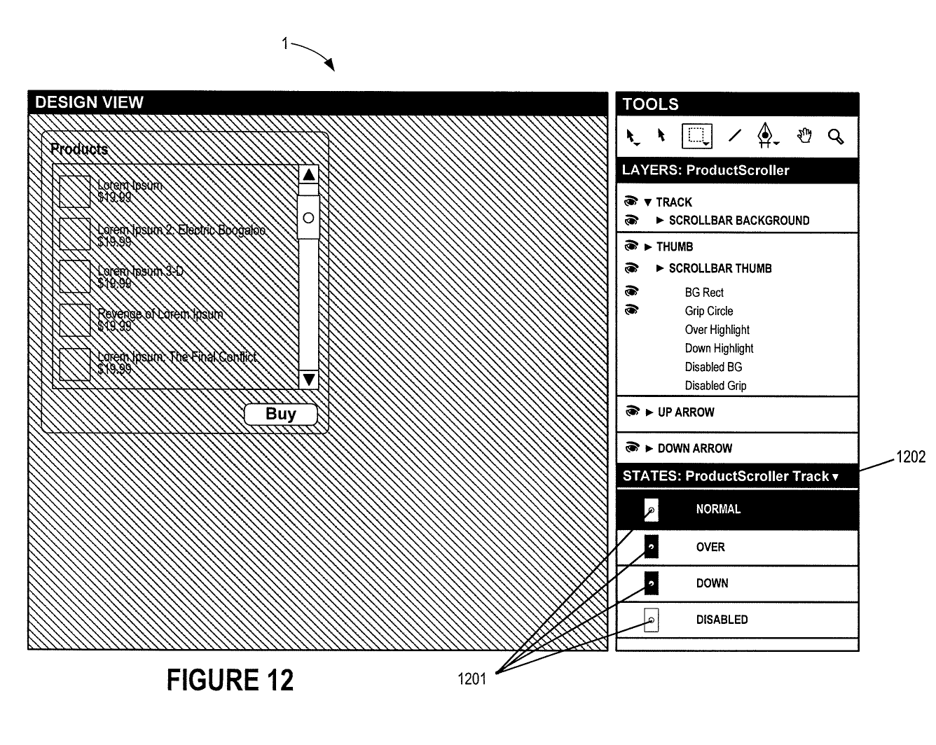

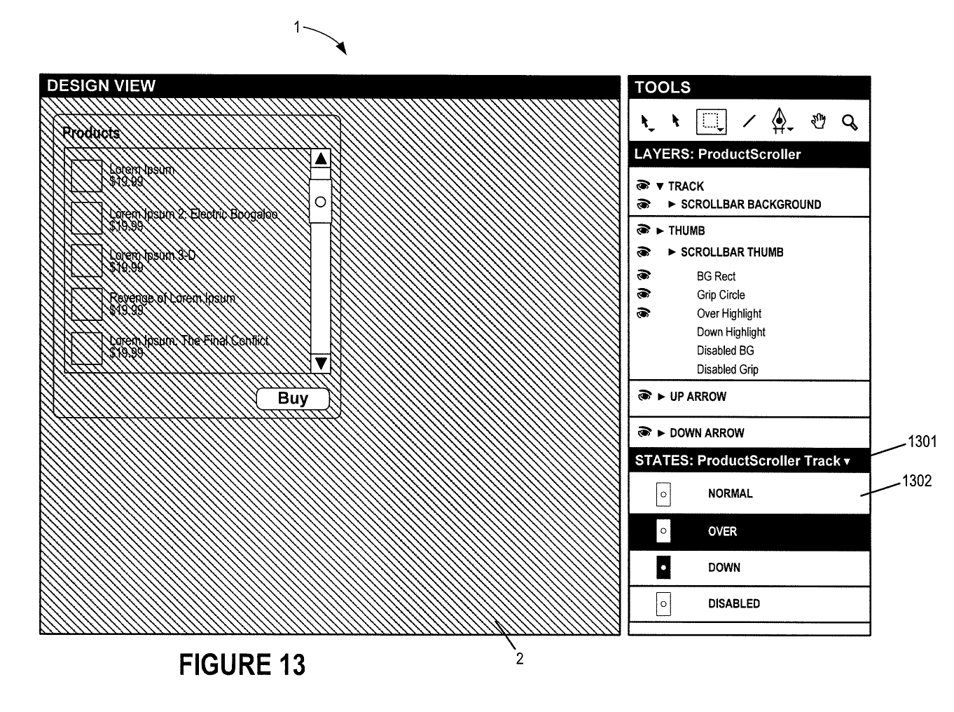

FIGS. 11-13 illustrate how an application development tool interface may look after a developer has associated artwork fragments into appropriate parts of a multi-part component. For example, the states 1101 of the track show only the track artwork fragments 1102 and the thumb artwork 1201 has been moved into the thumb part 1202. Note that when the OVER state 1302 of the thumb part of the scrollbar component is selected in the states layer 1301, the design view area 2 changes to display the OVER state appearance 1303.

### General

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention. For example, the idea of extracting information from static artwork and using that information to construct a working application can be applied to data other than artwork fragments. Other information might include: specific visual properties such as color or effects (e.g. shadow, bevel); text properties such as font and size; sample data—the static artwork might contain a text string (such as “Lorem ipsum”) or an image, which is not intended to appear in the finished application but which can be saved with the component for use as “sample data” at author-time, when no real data is available; layout information, such as the relative placement of different parts; and so on.

1. A method comprising:
displaying artwork in a design view interface of an application development environment, wherein the artwork was imported into or created in the design view interface;
receiving a selection of a selected component type for a component to be added to the design view interface;
receiving a selection of a selected fragment of the artwork for replacement with the component of the selected component type, the selected fragment having a fragment location in the artwork displayed in the design view interface; and
replacing the selected fragment of the artwork in the design view interface based on the selected fragment being selected for replacement with the component of the selected component type, wherein replacing the selected fragment comprises removing the selected fragment of the artwork and inserting the component at the fragment location in the design view interface, the component having the selected component type, the component comprising an appearance defined based at least in part on appearance of the selected fragment of the artwork.

2. (canceled)

3. The method of claim 1, wherein the selected fragment from the artwork is stored in a separate document.

4. The method of claim 1, wherein the design view interface of the application development environment is used to develop a user interface of an application.

5. The method of claim 1, wherein the design view interface of the application development environment is presented in an interactive window.

6. The method of claim 1, wherein the component is selected from the group consisting of a button, a checkbox, or a data grid.

7. The method of claim 1 further comprising removing the selected fragment from the artwork displayed in the design view interface.

8. The method of claim 1, wherein the selected fragment is a designer defined object.

9. The method of claim 8, wherein the object is a box representing the boundaries of a button.

10. The method of claim 1 further comprising:
receiving a selection of a second selected fragment of the artwork; and
receiving at least one instruction to define the appearance of the component using the selected fragment and second selected fragment.

11. The method of claim 10, wherein the selected fragment defines an appearance of the component in a first state and the second selected fragment defines an appearance of the component in a second state.

12. The method of claim 11, wherein the selected fragment is used as a first state of the component and the second selected fragment is used as a second state of the component.

13. The method of claim 12, wherein the component is a button and the first state is up and the second state is down.

14. The method of claim 1 further comprising:
receiving multiple selections of fragments of the artwork; and
receiving instructions to assigning each fragment selected by the multiple selection of fragments to at least one part of the component.

15. The method of claim 1, wherein receiving the selection of the selected fragment occurs before receiving the selection of the selected component type.

16. The method of claim 1, wherein receiving the selection of the selected fragment occurs after receiving the selection of the selected component type.

17. The method of claim 1, wherein the artwork is a multi-layered image, wherein the selected fragment comprises a plurality of overlapping layers, each layer having a respective fragment, wherein replacing the selected fragment comprises defining a respective appearance for each of a plurality of states of the component based at least in part on a respective one of the plurality of layers having the respective fragment.

18. (canceled)

19. The method of claim 1, wherein the artwork comprises both visible and invisible objects.

20. A method comprising:
displaying artwork in a design view interface of an application development environment, wherein the artwork was imported into or created in the application development environment, wherein the design view is configured for modifying a graphical interface of an application in a development mode;
providing a selection tool, the selection tool allowing use of a selector to select a portion of the artwork displayed in the design view interface;
receiving a selection of a selected portion of the artwork displayed in the design view interface; and
identifying visible and invisible artwork fragments that occupy the selected portion of the artwork displayed in the design view interface based on the selection received in the design view interface;
selecting the identified visible and invisible artwork fragments for use in defining an appearance of a component in developing the application in the application development environment.

21. The method of claim 20, wherein the artwork is a multi-layered image, wherein identifying the visible and invisible artwork fragments comprises:
identifying a first layer in the selected portion having a first visibility attribute set to a first value for rendering the first layer in the design view interface such that the first layer is visible; and
identifying a second layer in the selected portion having a second visibility attribute set to a second value for hiding the second layer from the design view interface such that the second layer is invisible.

22. The method of claim 20, wherein the artwork comprises groups of objects.

23. The method of claim 20, wherein the artwork fragments that are identified as occupying the selected portion are entirely within the selected portion.

24. The method of claim 20, wherein the artwork fragments that are identified as occupying the selected portion are entirely or partially within the selected portion.

25. A method of associating multiple image fragments with an application component for use in developing an application in an application development environment, the method comprising:
displaying artwork in a design view interface of an application development environment;
receiving at least one selection in the design view interface identifying multiple fragments of the artwork as displayed in the design view interface;
based on the at least one selection, assigning the multiple fragments of the artwork to a component for inclusion in a graphical interface for the application; and
providing a development interface that presents an image fragment list comprising the multiple fragments assigned to the component.

26. The method of claim 25 further comprising receiving an instruction to add an image fragment to the image fragment list.

27. The method of claim 25 further comprising receiving an instruction to delete an image fragment to the image fragment list.

28. (canceled)

29. The method of claim 28, further comprising assigning each fragment to at least one respective state of the component.

30. A non transitory computer readable medium on which is encoded program code for developing an application in an application development environment, the program code comprising:
program code for displaying artwork in a design view interface of an application development environment, wherein the artwork was imported into or created in the design view interface;
program code for receiving a selection of a selected component type for a component to be added to the design view interface;
program code for receiving a selection of a selected fragment of the artwork for replacement with the component of the selected component type, the selected fragment having a fragment location in the artwork displayed in the design view interface;
program code for replacing the selected fragment of the artwork in the design view interface based on the selected fragment being selected for replacement with the component of the selected component type, wherein replacing the selected fragment comprises removing the selected fragment of the artwork and inserting the component at the fragment location in the design view interface, the component having the selected component type, the component comprising an appearance defined based at least in part on appearance of the selected fragment of the artwork.

31. A system for developing an application, the system comprising:
a processor configured to execute instructions stored in memory to perform steps comprising:
displaying artwork in a design view interface of an application development environment, wherein the artwork was imported into or created in the design view interface;
receiving a selection of a selected component type for a component to be added to the design view interface;
receiving a selection of a selected fragment of the artwork for replacement with the component of the selected component type, the selected fragment having a fragment location in the artwork displayed in the design view interface; and
replacing the selected fragment of the artwork in the design view interface based on the selected fragment being selected for replacement with the component of the selected component type, wherein replacing the selected fragment comprises removing the selected fragment of the artwork and inserting the component at the fragment location in the design view interface, the component having the selected component type, the component comprising an appearance defined based at least in part on appearance of the selected fragment of the artwork.

32. The method of claim 20 wherein use of the selector tool to select a portion of the artwork comprises controlling a selection marquee to approximately cover a screen area of a component being defined.

33. The method of claim 20 wherein the identifying visible and the invisible artwork fragments comprises identifying all individual artwork fragments that visually contribute to a screen area identified by the selected portion of the artwork, ignoring any layers and any groups of an original structure of the artwork.

34. (canceled)

35. The method of claim 1, further comprising setting the application development environment to a component creation mode for generating functional interface components from nonfunctional artwork fragments, wherein the selection of the selected component type and the selection of the selected fragment for replacement are received in the component creation mode, wherein replacing the selected fragment of the artwork in the design view interface based on the selected fragment being selected for replacement with the component of the selected component type comprises replacing the selected fragment of the artwork in the design view interface based on the selected component type and the selected fragment being selected in the component creation mode.
